(19) United States
(12) Patent Application Publication
(10) Pub. No.: US 2008/0130836 A1
(43) Pub. Date: Jun. 5, 2008

(54) METHOD FOR DIRECTING X-RAYS THAT CAN BE RADIATED BY AN X-RAY EMITTER ONTO A DETECTOR AREA OF AN X-RAY DETECTOR

(76) Inventor: Rainer Graumann, Hochstadt (DE)

Correspondence Address: SCHIFF HARDIN, LLP;PATENT DEPARTMENT, 6600 SEARS TOWER, CHICAGO, IL, 60606-6473, US

(21) Appl. No.: 11/740,364

(22) Filed: Apr. 26, 2007

(30) Foreign Application Priority Data
May 11, 2006 (DE) 10 2006 022 141.9

(51) Int. Cl. G03B 42/02

(52) U.S. Cl. 378/177

(57) ABSTRACT

In a method for directing X-rays radiated by an X-ray emitter onto a detector area of a X-ray detector, a location and/or positioning of the X-ray emitter and a location and/or positioning of the detector area of the X-ray detector is/are registered by a position registering device, with the location and/or positioning of the X-ray emitter and/or the location and/or positioning of the detector area of the X-ray detector being adjusted using the registered location and/or positioning of the X-ray emitter and the registered location and/or positioning of the detector area of the X-ray detector such that the X-rays radiated by the X-ray emitter will for the most part strike the entire detector area of the X-ray detector.

### BACKGROUND OF THE INVENTION

1. Field of the Invention

The present invention relates to a method for directing X-rays that are radiated by an X-ray emitter onto a detector area of an X-ray detector.

2. Description of the Prior Art

X-ray techniques today can be found in many embodiments within medical engineering, in particular in the field of medical X-ray engineering. Imaging is an area in which techniques of said kind play a particularly significant role in medical engineering; they range from computed tomography techniques to C-arm X-ray techniques and the production of two-dimensional projections of an object undergoing examination.

X-ray techniques are applied radiologically, mainly during the performance of diagnostic examinations, as well as fluoroscopically, in performing angiographies, for instance, and locating medical instruments etc. It is always a goal due, to the ionizing effect of radiation, to minimize the radiation dose to which the patient is exposed, while selecting a radiation dose that will be sufficiently high to insure adequate imaging quality.

Particularly in the case of simply designed mobile X-ray devices, it can be difficult to mutually orient the X-ray emitter and X-ray detector in such a way that the detector area of a detector will be fully utilized. That is because with X-ray devices of this type the X-ray emitter is not—as in the case of, for example, a C-arm X-ray device—mechanically linked to the X-ray detector; the X-ray detector can instead have any location and positioning virtually independently of the X-ray emitter. Moreover, the X-ray detector is usually barely visible during the examination since the object undergoing examination is positioned on the X-ray detector for the examination.

It therefore has to be insured that a substantial portion of the X-rays radiated by the X-ray emitter will not miss the detector area of the X-ray detector. That is conventionally achieved by using an X-ray-restricting device to highly restrict the X-rays so that they will very probably strike the detector area. The size of the region in the object undergoing examination that is being irradiated will consequently be undesirably reduced and only a small portion of the X-ray detector's detector area used. Owing to this X-ray restricting, to insure that a large portion of the X-rays will strike the X-ray detector, the object undergoing examination may have to be exposed to X-rays more than once, which will increase the length of treatment for the object undergoing examination as well as the amount of energy required for performing the examination.

### SUMMARY OF THE INVENTION

An object of the present invention is to provide a method enabling improved utilization of X-rays emitted by an X-ray emitter.

This object is achieved according to the invention by a method for directing X-rays radiated by an X-ray emitter onto a detector area of an X-ray detector, with a location and/or positioning of the X-ray emitter and a location and/or positioning of the X-ray detector's detector area being registered by a position registering device, with the location and/or positioning of the X-ray emitter and/or the location and/or positioning of the detector area of the X-ray detector being adjusted using the registered location and/or positioning of the X-ray emitter and the registered location and/or positioning of the detector area of the X-ray detector such that the X-rays radiated by the X-ray emitter will for the most part strike the entire detector area of the X-ray detector.

The inventive method enables improved utilization of X-rays of an X-ray emitter because the dimension of an X-ray bundle of the X-rays will for the most part be accommodated to the dimensions of the detector area of the X-ray detector. Inventively adjusting the X-ray emitter and X-ray detector will not require any markings on the patient that would be visible in projections produced by means of X-rays and may disruptively affect a display that can be obtained from the projections.

Rather it is the case that the X-ray bundle is enabled to be accommodated by the position registering device that registers the X-ray emitter's or, as the case may be, X-ray detector's location (spatial siting) and/or positioning, namely its orientation in space. It is thus possible by means of the position registering device to register both absolute values for the location and/or positioning of the X-ray emitter and X-ray detector and relative values for the mutual location and/or positioning of the X-ray emitter and X-ray detector. The location and/or positioning of the X-ray emitter relative to the X-ray detector can be registered by a position registering device located, for example, only on the X-ray emitter and only on the X-ray detector. According to the invention the location and/or positioning of the X-ray emitter and/or the location and/or positioning of the X-ray detector are/is usually adjusted before the object undergoing examination is exposed to X-rays. The object undergoing examination may or may not already have been positioned between the X-ray emitter and X-ray detector while the location and/or positioning of the X-ray emitter are/is being adjusted and/or the location and/or positioning of the X-ray detector are/is being adjusted.

The method can be advantageously applied when, for the X-ray examination being performed, an X-ray detector is employed that is not rigidly mechanically linked to the X-ray emitter, but can be almost freely positioned and may not be visible during the X-ray examination because, for example, the object undergoing examination and is positioned on or in front of the X-ray detector. That can be the case, for instance, when X-ray examinations are performed on immobile, for example comatose, patients.

In an embodiment of the invention the registered location and/or positioning of the X-ray emitter and the registered location and/or positioning of the detector area of the X-ray detector are displayed graphically. The medical personnel can thereby quickly obtain an overview of the location and positioning of the X-ray emitter and X-ray detector. The relative location and/or positioning of the X-ray emitter and X-ray detector are displayed graphically preferably on an input/output device located on the X-ray device.

The location and/or positioning of the X-ray emitter and/or X-ray detector can be adjusted on the input/output device embodied as, for instance, a touchscreen. The X-ray emitter's and/or X-ray detector's location and/or positioning adjusted by the medical personnel by means of the input/output device can then be fed to a control device which controls a drive device of the X-ray emitter or, as the case may be, X-ray detector in such a way that the X-ray emitter's and/or X-ray detector's location and/or positioning specified by means of the touchscreen will be assumed.

The location and/or positioning of the X-ray emitter and/or X-ray detector can alternatively be adjusted manually by moving the X-ray emitter and/or X-ray detector manually and, where applicable, checking the X-ray emitter's and/or X-ray detector's adjusted location and/or positioning using the graphic display.

In a further embodiment of the invention a curve of a spatial propagation of the X-rays that can be radiated by the X-ray emitter is displayed graphically. A utilization of the detector area can thereby be even better identified in the graphic display. Only the edge rays of the X-rays need be displayed for achieving inventive adjusting of the X-ray emitter's location and/or positioning relative to the X-ray detector's location and/or positioning. The totality of X-rays can alternatively be displayed in the graphic display, for example as a diverging bundle of rays. The display can be a spatial display of the arrangement of the X-ray emitter and X-ray detector. The curve of the spatial propagation can be determined by means of, for example, a calibration, or calculated on the basis of the present geometric arrangement of the X-ray emitter and X-ray detector.

Side views and, where applicable, front views or top views onto the arrangement of the X-ray emitter and X-ray detector can likewise be displayed. The color display of the X-rays is preferably different from the color display of the X-ray emitter and X-ray detector to make it easy for the medical personnel to identify in which arrangement the X-rays will for the most part strike the entire detector area of the X-ray detector.

In a further embodiment of the invention, manual adjusting of the location and/or positioning of the X-ray emitter and/or the location and/or positioning of the detector area of the X-ray detector is prompted in such a way by means of a graphic display that the X-rays radiated by the X-ray emitter will for the most part strike the entire detector area of the X-ray detector. The possibility of manually adjusting the location and/or positioning of the X-ray emitter and/or the location and/or positioning of the X-ray detector will make it possible to pay particular attention to the ambient area of the examination and to the boundary conditions predefined thereby for the examination.

By means of a control device it is possible on the basis of, for example, the geometric arrangement of X-ray emitter and X-ray detector and the propagation of the X-rays to determine an evaluation parameter for the utilization of the detector area within said arrangement.

If the evaluation parameter that has been determined indicates a detector area utilization that is poorer than a threshold stored for said evaluation parameter in, for instance, the control device, then the control device will be able via the graphic display on the input/output device to propose changing the location and/or positioning of the X-ray emitter and/or X-ray detector to bring the evaluation parameter of the arrangement closer to the stored evaluation parameter and thereby achieve improved utilization of the detector area of the X-ray detector.

A proposal can be displayed by means of, for example, arrows in the graphic display indicating the direction in which the X-ray detector and/or X-ray emitter are/is to be moved for achieving an improvement in the utilization of the detector area. The location and/or positioning of the X-ray emitter or the X-ray detector can be changed by the medical personnel in keeping with the proposed direction for changing the location and/or positioning of the X-ray emitter or the X-ray detector.

In a further embodiment of the invention the location and/or positioning of the X-ray emitter are/is adjusted in a motorized manner and/or the location and/or positioning of the detector area of the X-ray detector are/is adjusted in a motorized manner by means of a controlled drive device in such a way that the X-rays radiated by the X-ray emitter will for the most part strike the entire detector area of the X-ray detector. The location and/or positioning of the X-ray emitter and/or X-ray detector can be adjusted automatically on the basis of geometric data that also includes, for example, the relative location and/or positioning of the X-ray emitter and X-ray detector, the propagation of X-rays emitted by the X-ray emitter, and the region being examined in the object undergoing examination, etc.

A graphic display is not absolutely essential in an automated embodiment of adjusting. In the case of an automated implementation an inquiry is preferably first directed at the medical personnel to establish whether the calculated location and/or positioning and the proposed change associated therewith to the location and/or positioning of the X-ray emitter or, as the case may be, X-ray detector for improving the evaluation parameter or the utilization of the detector area is accepted. Collision sensors are furthermore to be provided in order to avoid collisions between the X-ray emitter or, as the case may be, X-ray detector and other objects when the location and/or positioning of the X-ray emitter or X-ray detector are/is changed automatically.

In a further embodiment of the invention the location and/or positioning of the X-ray emitter and the location and/or positioning of the detector area of the X-ray detector are adjusted in such a way that the X-rays radiated by the X-ray emitter will for the most part strike perpendicularly and for the most part the entire detector area of the X-ray detector.

That can be advantageous particularly when a spatial display of an object undergoing examination is to be obtained, with the X-ray emitter and X-ray detector not being mutually linked rigidly mechanically. It is advantageous for the location and/or positioning of the X-ray emitter always to be changed in such a way that on the one hand the detector area of the X-ray detector will be fully utilized and, on the other hand, it will be insured that the X-rays will for the most part impinge perpendicularly. That will make it easier to obtain a spatial display because distortion correcting will not be necessary for each projection contributing to obtaining the spatial display. That would need to be performed if the central axis of the X-rays deviated substantially from the direction perpendicular to the detector area of the X-ray detector, such as if the X-rays do not perpendicularly strike the detector area of the X-ray detector.

In a further embodiment of the invention, when the location and/or positioning of the X-ray emitter and the location and/or positioning of the detector area of the X-ray detector have been adjusted such that the X-rays radiated by the X-ray emitter will for the most part strike the X-ray detector's entire detector area, at least one restricting parameter of an X-ray-restricting device will be accommodated in such a way that the X-rays radiated by the X-ray emitter will precisely strike the entire detector area of the X-ray detector.

By using an X-ray-restricting device it will be possible, for example when the ambient area of the examination imposes boundary conditions that oppose changing the location and/or positioning of the X-ray emitter and/or X-ray detector in a desired manner, to adjust the X-rays for the most part or precisely to the dimensions of the detector area of the X-ray detector. It will also be possible to adjust the X-rays precisely to the detector area if inventive adjusting of the location and/or positioning of the X-ray emitter or, as the case may be, X-ray detector is possible. The restricting parameter of the X-ray-restricting device can be accommodated automatically or manually. The influence of different restricting parameters of the X-ray-restricting device on the curve of the propagation of the X-rays preferably can be displayed in a graphic display on the input/output device. That will allow adjusting of the X-ray-restricting device to be checked graphically before the object undergoing examination is exposed to X-rays.

### DESCRIPTION OF THE DRAWINGS

FIG. 1 shows a medical workstation for implementing the method according to the invention,

FIG. 2 is a flowchart illustrating the method according to the invention.

### DESCRIPTION OF THE PREFERRED EMBODIMENTS

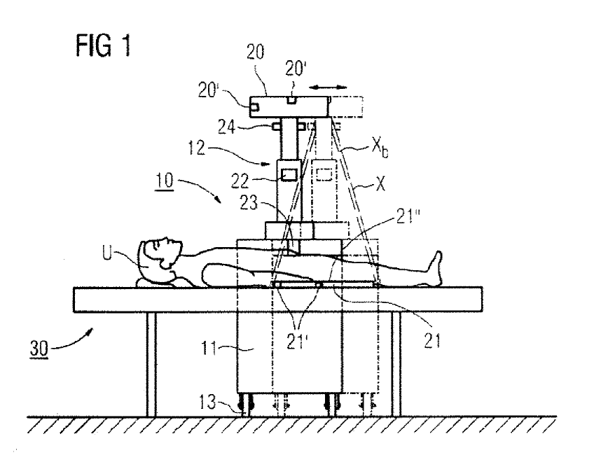

FIG. 1 shows a movable X-ray device 10 positioned near an immobile object undergoing examination U. The movable X-ray device 10 has a stand unit 11 borne on caster elements 13. Further provided is a support device 12 that consists of a plurality of elements that can be moved relative to each other and on which is positioned an X-ray emitter 20 by which X-rays X can be radiated. The support device 12 is borne movably by the stand unit 11. By means of the support device 12 that is embodied as a support arm the X-ray emitter 20 can be rotated and/or moved relative both to the object undergoing examination U and to the stand unit 11. The X-ray emitter 20 is furthermore borne movably relative to the support arm 12 so that it can be rotated around a rotational axis that is perpendicular to the drawing plane and passes through the midpoint of the X-ray emitter 20.

The X-ray emitter 20 furthermore has a number of positions registering send elements 20′ that allow the location and positioning of the X-ray emitter 20 relative to the stand unit 11 to be determined. The stand unit 11 has for that purpose a number of position registering reception elements 22 and 23 by means of which the signals for registering the location and positioning of the X-ray emitter 20 that are emitted by the position registering transmission elements 20′ of the X-ray emitter 20 are received.

An X-ray detector 21 is furthermore required for subjecting the object undergoing examination U to an X-ray examination using X-rays X. The X-ray detector 21 has a detector area 21″. X-rays X striking the detector area 21″ will be detected with a certain quantum efficiency dependent on the detection material and detection mechanism employed. Like the X-ray emitter 20, the X-ray detector 21 also has a number of position registering send elements 21″ for registering a location and/or positioning of the X-ray detector 21 or the detector area 21″ relative to the stand unit 11.

The X-ray detector 21 is connected to the stand unit 11 by means of a cable for exchanging data and, where applicable, for supplying power and so can be positioned virtually freely, within the scope of the pre-specified cable parameters, relative to the object undergoing examination U or, as the case may be, the stand unit 11 or the X-ray emitter 20.

Positions can be registered for example optically, using electromagnetic waves, or by means of a high-frequency signal. Position registering devices employing other methods and means can alternatively also be provided.

The X-ray device 10 furthermore has an X-ray-restricting device 24. In the exemplary embodiment the X-ray-restricting device 24 is embodied as a rectangular diaphragm having a size-adjustable rectangular diaphragm aperture. The rectangular diaphragm 24 is made from a material—lead, for example—that absorbs the X-rays X. The size of the diaphragm aperture of the rectangular diaphragm 24 through which the X-rays X radiated by the X-ray emitter 20 are radiated is a possible settable diaphragm parameter. A further restricting parameter is the distance between the X-ray emitter 20 and the rectangular diaphragm 24 or, as the case may be, between an X-ray source (not shown) located inside the X-ray emitter 20 and the X-ray-restricting device 24.

The restricting parameters can be set by means of a drive device (not shown) controlled by a control device. Said control device (also not shown) is preferably located inside the stand unit 11. The stand unit 11 further includes an input/output device (not shown) by means of which it is possible to input control instructions and output graphic displays. An X-ray X_{b} restricted by the rectangular diaphragm 24 is shown in FIG. 1.

The X-ray detector 21 is pushed under the object undergoing examination U for implementing the X-ray examination to be performed on the immobile object undergoing examination U. The X-ray detector 21 will consequently for the most part no longer be visible for the medical personnel or, as the case may be, will be obscured by the object undergoing examination U. Before the examination starts it is necessary, advantageously without exposing the object undergoing examination U to radiation, to direct the X-ray emitter 20 onto the X-ray detector 21 obscured at least in part by the object undergoing examination U.

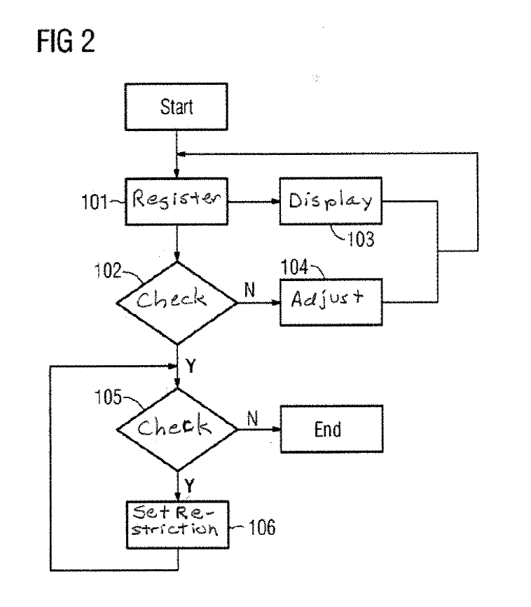

FIG. 2 is a flowchart showing the steps of the method for directing an X-ray emitter onto a detector area of an X-ray detector. This flowchart is explained below in conjunction with the medical workstation shown in FIG. 1, with reference numerals of equipment components relating to FIG. 1.

The flowchart shown in FIG. 2 presupposes that the X-ray device 10 shown in FIG. 1 is already positioned near an object undergoing examination U and that an X-ray detector 21 having a detector area 21″ directed approximately towards the X-ray emitter has been pushed under the object undergoing examination U.

The location and positioning of the X-ray emitter 20 relative to the stand unit 11 are registered at a first step 101 of the method through, for example, the medical personnel's starting a sending procedure for the position registering send elements 20′ of the X-ray emitter 20 and for the position registering send elements 21′ of the X-ray detector 21. The signals that are sent are received by a number of position registering receive elements 22 and 23 and fed to a control device that is not shown in FIG. 1. A location and positioning of the X-ray emitter 20 and a location and positioning of the X-ray detector 21 are determined from the position registering signals fed to the control device and, at a step 103 of the method, displayed graphically on an input/output device that is not shown in FIG. 1.

The graphic display shows not only, accurate to scale, the location and positioning of the X-ray emitter 20 relative to the X-ray detector 21 but also the curve of the spatial propagation of X-rays X that can be radiated by the X-ray emitter 20. At that moment, though, preferably no X-rays X are yet being radiated by the X-ray emitter 20.

A check is then carried out at a step 102 of the method to determine whether the X-rays X that can be radiated by the X-ray emitter 20 would for the most part strike the entire detector area 21″ of the X-ray detector 21. It is therein desired for the entire detector area 21″ of the X-ray detector 21 to be utilized during the examination. That means that for the most part no X-rays X should miss the detector area 21″ or, as the case may be, the X-ray detector 21, and that the X-rays X should not use just a small portion of the detector area 21″ of the X-ray detector 21.

Inventive adjusting of the location and/or positioning of the X-ray emitter 20 relative to the location and/or positioning of the X-ray detector 21 is generally not provided during initial adjusting for directing an X-ray emitter 20 onto an X-ray detector 21 for the most part obscured by the object undergoing examination U.

The X-ray emitter 20 is directed onto the X-ray detector 21 at a step 104 of the method based on the location and positioning of the X-ray emitter 20 or, as the case may be, X-ray detector 21 that were registered at step 101 of the method. This adjusting of the X-ray emitter 20 and X-ray detector 21 can be carried out automatically or manually. The medical personnel can in the case of manual adjusting be prompted by graphic symbols on the input/output device that is not shown in FIG. 1. The use of symbols therein enables prompting that is not speech-based, resulting in greater flexibility for all kinds of personnel. The changed location and positioning of the X-ray emitter 20 and X-ray detector 21 are then registered at step 101 of the method and fed out in graphic display at a step 103 of the method. Another check is carried out at a step 102 of the method to determine whether the X-ray emitter 20 and X-ray detector 21 have been positioned in such a way that the X-rays X that can be radiated by the X-ray emitter 20 will for the most part strike the entire detector area 21″ of the X-ray detector 21.

If that is not the case then the loop of the method having the steps thereof 101, 102, 103, and 104 will keep being repeated until the X-ray emitter 20 and X-ray detector 21 have been adjusted in such a way that the X-rays X that can be radiated by the X-ray emitter 20 will for the most part strike the entire detector area 21″ of the X-ray detector 21.

Owing to boundary conditions predefined by an ambient area of an examination the case may arise that through adjusting alone of the location and/or positioning of the X-ray emitter 20 or, as the case may be, X-ray detector 21 the X-rays that can be radiated will not utilize the detector area adequately, or, as the case may be, the detector area 21″ will be missed by a substantial portion of the X-rays X. Boundary conditions of said type can assume the form of, for example, other medical devices and equipment. Owing to said boundary conditions' having to be taken into account it is possible, for example, that a substantial portion of the X-rays X will miss the detector area 21″ of the X-ray detector 21.

Missing of the detector area 21″ or small spatial use of the detector area 21″ by the X-rays X that can be radiated by the X-ray emitter 20 can be quickly identified with the aid of the graphic display obtained at step 103 of the method.

A check is therefore provided at a step 105 of the method to determine whether restricting of the X-rays X is necessary using an X-ray-restricting device 24. If restricting of the X-rays X is necessary then a restricting parameter for restricting the X-rays X will be set at a step 106 of the method in such a way that at least the exposure of the object undergoing examination U to radiation will be reduced by masking out X-rays X that would in any event miss the detector area 21″ of the X-ray detector 21 by reducing the size of the aperture of the X-ray-restricting device 24. Thus only restricted X-rays X_{b} will then be available for the examination.

The X-ray-restricting device 24 can alternatively be used at a step 106 of the method for even better utilizing the detector area 21″ in an inventive arrangement of the X-ray emitter 20 and X-ray detector 21 by adapting a restricting parameter of the X-ray-restricting device 24 in such a way that the X-rays X radiated by the X-ray emitter 20 will strike precisely the entire detector area 21″ of the X-ray detector 21.

If, following a check on how the X-rays X are being directed onto the detector area 21″ of the X-ray detector 21, no further changes are necessary to how the location and/or positioning of the X-ray emitter 20 or, as the case may be, X-ray detector 21 have/has been adjusted, and no further changes are necessary to how the restricting parameter of the X-ray-restricting device 24 has been set, then the method for directing the X-rays X onto a detector area 21″ of the X-ray detector 21 will be complete.

The X-ray examination can thereafter be performed with either reduced exposure to radiation for the object undergoing examination U or improved utilization of the detector area 21″ of the X-ray detector 21.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for directing X-rays radiated by an X-ray emitter onto a detector area of an X-ray detector, comprising the steps of:
automatically non-manually registering a spatial characteristic, selected from the group consisting of location and positioning, of an X-ray emitter and a spatial characteristic, selected from the group consisting of location and positioning, of a detector area of an X-ray detector; and
adjusting at least one of the spatial characteristic of the X-ray emitter and the spatial characteristic of the detector area of the X-ray detector using at least one of the registered spatial characteristic of the X-ray emitter and the registered spatial characteristic of the detector area of the x-ray detector to cause X-rays radiated by said X-ray emitter to strike an entirety of said detector area of said X-ray detector.

2. A method as claimed in claim 1 comprising graphically displaying the registered spatial characteristic of the X-ray emitter and the registered spatial characteristic of the detector area of the X-ray detector.

3. A method as claimed in claim 2 comprising also graphically displaying a curve of a spatial propagation of said X-rays radiated by said X-ray radiator.

4. A method as claimed in claim 1 wherein the step of adjusting at least one of said spatial characteristic of said x-ray emitter and said spatial characteristic of said detector area of the X-ray detector comprises manually setting said at least one of said spatial characteristic of said X-ray emitter and said spatial characteristic of said detector area of said X-ray detector.

5. A method as claimed in claim 1 wherein the step of adjusting at least one of said spatial characteristic of said x-ray emitter and said spatial characteristic of said detector area of the X-ray detector comprises automatically setting said at least one of said spatial characteristic of said X-ray emitter and said spatial characteristic of said detector area of said X-ray detector using a motor.

6. A method as claimed in claim 1 comprising adjusting said at least one of said spatial characteristic of said X-ray emitter and said spatial characteristic of said detector area of said X-ray detector to cause said X-ray radiator to strike said entirety of said detector area of said X-ray detector perpendicularly.

7. A method as claimed in claim 1 comprising restricting a spatial extent of said X-rays emitted by said X-ray radiator using an X-ray restricting device operating according to at least one restricting parameter, and comprising adjusting said at least one of said spatial characteristic of said X-ray radiator and said spatial characteristic of said detector area of said X-ray detector dependent on said at least one restricting parameter to cause all X-rays passing through said X-ray restricting device to collectively strike said entirety of said detector area of said X-ray detector.
